(19) United States
(12) Patent Application Publication
(10) Pub. No.: US 2019/0345051 A1
(43) Pub. Date: Nov. 14, 2019

(54) METHOD FOR PROVIDING ULTRAPURE WATER

(71) Applicant: VWS (UK) Limited, High Wycombe (GB)

(72) Inventor: James KEARY, High Wycombe (GB)

(73) Assignee: VWS (UK) Limited, High Wycombe (GB)

(21) Appl. No.: 16/472,028

(22) PCT Filed: Mar. 5, 2018
(86) PCT No.: PCT/GB2018/050549

§ 371 Date: Jun. 20, 2019

(30) Foreign Application Priority Data
Mar. 17, 2017 (GB) 1704257.3

(51) Int. Cl. C02F 9/00

(52) U.S. Cl. CPC C02F 9/00; C02F 1/441

(57) ABSTRACT

A method of sanitising a section of a water purification apparatus able to provide a purified water stream having a conductivity of less than 1 μS/cm at 25° C. to a dispense outlet, the water purification apparatus having a purified water recirculating section including at least one deioniser and the dispense outlet, comprising at least the steps of: (i) providing recirculation in the purified water recirculating section; (ii) providing ozone-generation in the purified water recirculating section after the at least one deioniser; (iii) allowing the ozone to circulate around the purified water recirculating section to sanitise at least the part of the purified water recirculating section having the dispense outlet; and (iv) using ultra violet radiation to stop the sanitising prior to the at least one deioniser. The use of in-line generated ozone to sanitise a water purifying stage has a number of advantages, including in particular automation, directly dissolved ozone, being environmentally friendly compared to the use of previous sanitisation materials such as chlorine tablets, and the avoidance of requiring any rinsing and flushing steps or cycles, with its attendant waste of water going to a drain only.

The present invention relates to a method for sanitising a section of a water purification apparatus using ozone sanitisation. Sanitising includes cleaning of microbial contamination and/or disinfection.

Water purification apparatus for use in laboratories and healthcare facilities are well known. Generally they involve the reduction and/or removal of contaminants and impurities to very low levels from a water source, as well as any impurities originating from within the apparatus itself. They typically contain a variety of technologies that remove particles, bacteria, ionic species, organic substances and/or molecules. These technologies are linked by tubes or pipes that make up a large part or even the majority of the wetted surfaces within the water purification apparatus.

One very important parameter for the water produced by water purification apparatuses for many purified water applications is that the bacteria levels are less than prescribed limits. As well as limits on viable bacteria, frequently there are limits on bacterial by-products such as endotoxins, RNase, DNase, alkaline phosphatase, etc., as each of these impurities can have detrimental effects on specific analysis or research.

Micro-organisms, including bacteria and their by-products, are routinely removed from high purity water by a number of techniques, including, but not limited to, reverse osmosis, micro-filtration, ultrafiltration, adsorption and UV irradiation. Despite this array of technologies, and maintaining active recirculation of the purified water, micro-organisms can, under some situations, still develop within the water purification apparatus, and in extreme cases can form biofilms on the wetted surface of components, tubing, pumps etc. These biofilms shed bacteria and bacterial by-products into the water, leading to contamination of the highly purified water, and in some cases leading to a requirement to replace the components themselves. Of particular importance is the existence of biofilm in the part of the water purification apparatus in the proximity of the water dispense outlet, i.e. after the final technology that removes bacteria from the water being purified. Many apparatus, particularly but not limited to smaller laboratory apparatus, can operate with intermittent periods of recirculation, and during periods of ‘non-recirculation’, bacteria may shed from biofilm located past the outlet of a recirculation loop. These bacteria will then diffuse upstream to the water dispense outlet, such as in or on the outlet valve, re-contaminating not only that section of the water purification apparatus.

Thus, regular sanitisation of the dispense section of the water purification apparatus is therefore required to ensure optimum performance of the apparatus, to reduce and hopefully eliminate especially bacteria or micro-organisms adhering to a surface therein.

Sanitisation of water purification apparatus is typically carried out by taking the apparatus ‘off line’, followed by the addition of hazardous chemicals which are generally circulated for a set period within the apparatus to ensure all micro-organisms are destroyed, before being rinsed or flushed out of the apparatus through the water dispense outlet. Naturally, it is important that all the chemicals are removed prior to return of the apparatus to normal usage, as cleaning chemicals are generally damaging or otherwise dangerous to the activities that the purified water is being applied to.

Such chemicals include chlorine-release tablets, peracetic acid and hydrogen peroxide. Naturally, it is preferred that the users of water purification apparatus do not even handle and use such hazardous chemicals. The risks of their incorrect use are obvious, and indeed may be catastrophic to the water purification apparatus.

Thus, whilst such hazardous cleaning chemicals can still be added manually, it is now preferred for them to be added from a dedicated container able to ensure the correct introduction, supply and dosage of the chemical or substance. Our WO 03/076321 Al shows a separable component adapted to sanitise and/or clean one or more parts of a host water treatment apparatus. The component is adapted to properly co-operate with the host apparatus, to ensure the correct introduction and supply of the sanitant in the component into the host apparatus.

However, all known sanitising systems and apparatus still require the rinsing and flushing out of the chemicals and residues from the water purification apparatus to a drain or to a waste receptacle, which has an environmental impact. These are flushed out by a stream or a series of streams of fresh water, all of which also go to the drain or to the waste receptacle. Naturally, it is desired to ensure the removal of the cleaning chemicals and residues to the greatest extent, such that significant volumes of water are required, especially to flush away the last remaining fractions of the cleaning chemicals and residues. This also has an environmental impact.

The rinsing and flushing can be determined by the user, which may not be desired, or can be automated such as in our WO2006/018606, which describes an automated method of determining when a cleaning operation has been carried out.

Alternatively our WO2010/043897 discloses capture of unused sanitant chemicals and breakdown products on a media but this may take several passes through the apparatus.

These methods require the storage and handling of sanitising or cleaning chemicals with associated hazard control under the Control of Substances Hazardous to Health (“COSSH”) or similar regulations and the associated training.

A further issue is that dedicated waste receptacles are required where the chemicals and residues are not allowed to be passed to a drain due to local or site limitations, also requiring separate off-site disposal. This off-site disposal increases the complication and cost of the sanitisation process.

It is an object of the present invention to provide an improved apparatus and method of sanitising or cleaning a section of a water purification apparatus.

According to one aspect of the present invention, there is provided a method of sanitising a section of a water purification apparatus able to provide a purified water stream having a conductivity of less than 1 μS/cm at 25° C. to a dispense outlet, the water purification apparatus having a purified water recirculating section including at least one deioniser and the dispense outlet, comprising at least the steps of:

(i) providing recirculation in the purified water recirculating section;

(ii) providing ozone-generation in the purified water recirculating section after the at least one deioniser;

(iii) allowing the ozone to circulate around the purified water recirculating section to sanitise at least the part of the purified water recirculating section having the dispense outlet; and

(iv) using ultra violet radiation to stop the sanitising prior to the at least one deioniser.

According to another aspect of the present invention, there is provided a water purification apparatus able to provide a purified water stream having a conductivity of less than 1 μS/cm at 25° C. to a dispense outlet, the water purification apparatus having:

a purified water recirculating section including at least one deioniser and the dispense outlet,

an ozone-generating unit able to sanitise at least a part of the purified water recirculating section having the dispense outlet; and

ultra violet radiation unit to stop the sanitising prior to the at least one deioniser.

The present invention will now be further described by way of example only and with reference to the accompanying drawings in which:

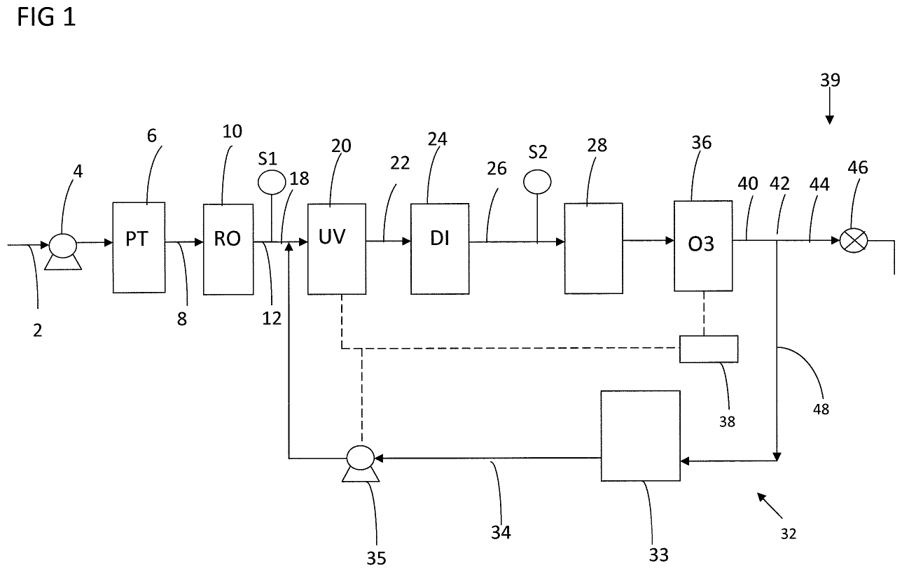

FIG. 1 is a schematic view of a water purification apparatus and method of sanitising according to a first embodiment of the present invention:

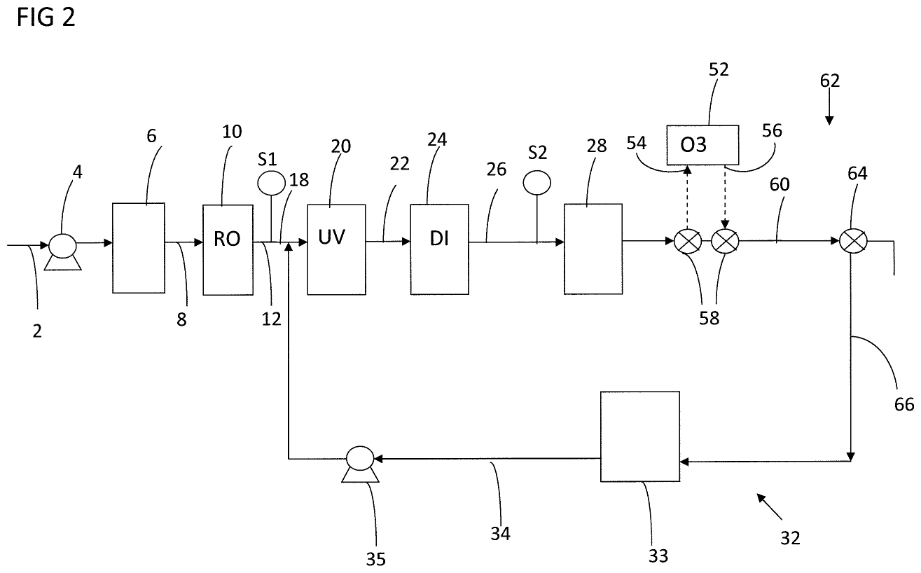

FIG. 2 is a schematic view of a water purification apparatus and method of sanitising according to a second embodiment of the present invention; and

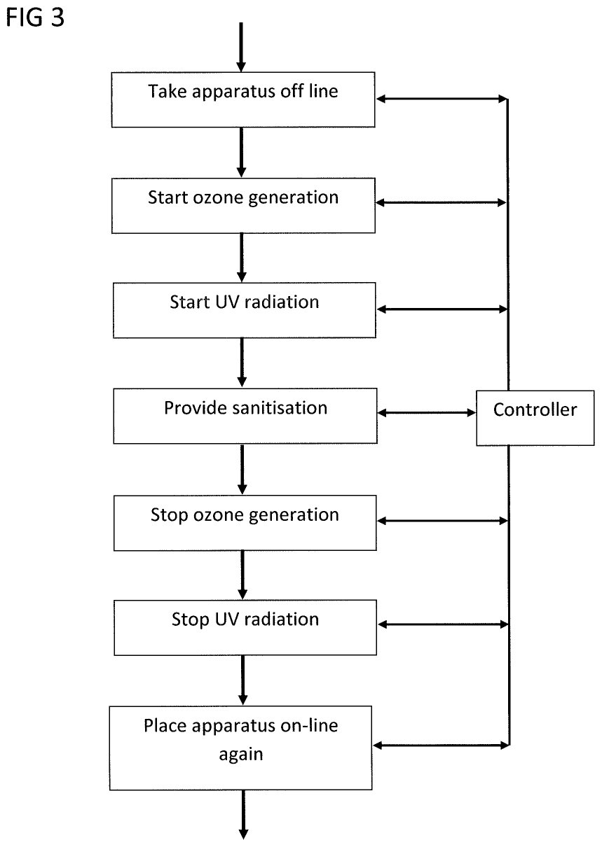

FIG. 3 is a flow diagram of operation of a method of sanitising according to another embodiment of the present invention.

Water purification apparatus for use in laboratories and healthcare facilities are well known. Generally they involve the reduction and/or removal of contaminants and impurities to very low levels from a potable or general water source such as a tap. Such feed typically has a range of particles, bacteria, ionic species and organic substances and/or molecules therein. The conductivity of the feed water can range from 50 to 1000 μS/cm at 25° C., or even more, depending on the source.

The present invention may relate to or be applied to a water purification apparatus having any arrangement of components or units able to be combined to provide ultra-pure water having a conductivity of less than 1 μS/cm at 25° C. The water purifying can be carried out in a single stage or in a series of stages, such as two or three water purifying stages, based on a series of purifying units, components or processes.

Optionally, the water purifying stage is part of a water purification apparatus further comprising one or more of the group comprising: reverse osmosis, ultrafiltration and microfiltration.

Optionally, such water purification apparatus may also include one or more pumps, sensors, valves, reservoirs etc. well know to the person skilled in the art, and not further described herein. These parts and the technologies are connected by lines, tubes or pipes to form the flowpath of the water purification apparatus. The flowpath may include sections where recirculation to maintain or enhance water purity is possible.

In one possible arrangement, the water purification apparatus comprises a first water purifying stage comprising reverse osmosis, and a second water purifying stage being the recirculating water purifying stage of a water purification apparatus.

Reverse Osmosis (RO) is a well known technology in the art, and uses selective permeation through thin membranes. The membranes remove water contaminates that are less than 1nm diameter, and typically remove over 90% of ionic contamination, most organic contamination, and nearly all particulate contamination.

An RO unit may comprise one or more parts, sections or portions, providing at least one RO pathway, optionally two RO pathways. Each pathway may be provided by a module, cartridge or cylinder, optionally operating in series, parallel or both. Optionally the concentrate provided by one or more of the pathways can be the inlet feed to one or more other pathways, and the or each permeates can be collected to provide a final permeate water output or stream from the RO process and/RO unit.

Optionally, feedwater is pre-treated prior to the reverse osmosis. The pre-treatment can comprise one or more processes and/or units, including but not limited to filtration through one or more filtration media, such as activated carbon, and the use of micro-porous filters. The pre-treatment is intended to particularly remove any particles, colloids, chlorine and chloramine which can affect subsequent processes or treatments in the water purification apparatus. Other water pre-treatment processes and units are known in the art, and the present invention is not limited by the nature, status or form of the pre-treatment.

The deionisation provided by the at least one deioniser of the present invention can be carried out using a number of known technologies and units or devices, optionally including ion exchange resins or resin beds. One particular technology for purifying water to a very high level is electro-deionisation (EDI), which applies an electric field across an ion exchange resin bed and uses ion-selective membranes to remove ionised species from water. Water passes through one or more chambers filled with ion exchange resins held between cation and anion selective membranes, so that the unwanted ions migrate through the ion exchange resins to separate chambers under the influence of the electric field, and can be flushed to waste from the separate chambers.

Another particular technology is capacitive deionisation (CDI), which passes a stream of water through one or more pairs of spaced apart electrodes having a high surface area and low-resistance, and which is able to remove ions from the water electrostatically for capture by the electrodes. CDI can run wholly or substantially continuously, thereby not requiring any periodic ‘replacement’, etc., other than occasional periodic current reversal to discharge collected ions once the electrodes are ‘full’.

Optionally, the capacitive deionisation is membrane capacitive deionisation (MCDI), which comprises a combination of CDI with the use of ion-exchange membranes placed in front of one or both of the electrodes, typically both electrodes. The ion-exchange membranes have a high internal charge due to having covalently bound groups such as sulfonate or quaternary amines, which allow easy access for one type of ion (the counter ion) and block access for the ion of equal charge sign (the co-ion).

Thus, the at least one deioniser is one or more of the group comprising: ion exchange resins, electro-deionisation unit, capacitive deionisation unit, and membrane capacitive deionisation unit.

Ultra-violet light or radiation is well known as being a bactericide, able to break down and photo-oxidise organic contaminates to polar or ionised species for subsequent removal by ion exchange. Typically the UV source is a low pressure mercury lamp, and typically the radiation has a wave length of 254 nm, optionally also 185 nm. The shorter wavelength can oxidise organics as it breaks larger organic molecules into smaller ionised components. Alternatively, UV emitting LEDs may be used. These may be arranged individually or in an array, and the energy emitted by the LED may be varied.

Thus, optionally, the present invention further comprises varying the ultra violet radiation used to stop the sanitising prior to the at least one deioniser.

Optionally, the purified water provided by the water purifying stage passes through one or more filters, such as microporous filters, ultrafilters and the like as a physical barrier to the passage of particles and microorganisms, such as protein macromolecules.

After purification, the ultrapure water of the present invention is able to provide ultra-pure water having a conductivity of less than 1 μS/cm at 25° C., ready for use and dispense, generally through one or more outlets such as a dispense tap or valve arrangement. The valve arrangement may incorporate 2-way or 3-way valves, typically solenoid or stepper motor valves, possibly further including a metering function. Optionally, the ultrapure water can be provided for distribution through one or more water distribution apparatus or networks.

In the present application, it is this section of the water purification apparatus, able to provide or dispense a user with the purified water stream, which is defined as the dispense outlet. This section can be integral with or separate from, or both, the other parts or sections of the water purification apparatus, in particular the recirculating section after the or each deioniser.

In one embodiment of the present invention, the section of the water purification apparatus able to provide the purified water stream extends from the recirculating section by tubing or piping, to a final dispense outlet, valve, tap or the like.

In another embodiment of the present invention, the section of the water purification apparatus able to provide the purified water stream is integral with the recirculating section, optionally based on a 3- or greater way valve.

Where immediate use of the purified water is not desired, optionally at least some of the purified water can be collected in a storage tank or reservoir. The term “reservoir” as used herein includes any unit, vessel or location able to collect ultrapure water for temporary storage and subsequent availability to a user. Because storage of purified water can lead to its reduced purity, optionally the present invention includes re-circulating at least some of the purified water in the reservoir through the or each deioniser of the water purifying stage.

In one embodiment of the present invention, wherein the purified water recirculating section further includes a purified water storage reservoir, the method comprises the further step of sanitising the purified water storage reservoir.

The re-circulation can be provided by a re-circulation circuit, which comprises a circuit for passing water stored in the reservoir through the UV radiation, the or each deioniser, and past the dispense section, and optionally back into the reservoir if still not required.

Regular sanitisation of a water purification apparatus is required to ensure optimum performance of the apparatus, and to reduce and hopefully eliminate any contaminants in the apparatus, such as bacteria or micro-organisms adhering to a surface therein.

Calculating the required disinfectant dosage for the chlorination of water can be based on a ‘concentration versus time’ value, often abbreviated to ‘CT value’. This is the product of the concentration of a disinfectant (e.g. free chlorine) and the contact time with the water being disinfected. It is typically expressed in units of mg-min/L. In practice, tables of the product of ‘C×T’ are used to calculate disinfection dosages.

These tables express the required CT values to achieve a desired removal of microorganisms of interest in drinking water for a given disinfectant under constant temperature and pH conditions.

Thus, and by way of example only, a frequent or regular, say weekly, sanitisation of a water purification apparatus could use 0.5 ppm ozone.minutes, i.e. a CT value of 0.5, whilst a more infrequent but deliberately stronger sanitisation process could use 3.5 ppm ozone.minutes, i.e. a CT value of 3.5. This could be for example for a half yearly sanitisation.

The generation of ozone is a well known process. An advantage of the present invention is the relatively ‘small scale’ generation of ozone that is required to sanitise a water purification apparatus intended to provide a purified water stream only having a conductivity of less than 1 μS/cm at 25° C. In particular, this allows the ozone-generation to be provided in the water purifying stage, optionally in-line in the water recirculating section. This contrasts with the conventional supply of ozone that is generated separately, for sanitising in conventional water purification apparatus. Conventionally, a separate ozone generator is provided, that must then be ‘plugged in’ or ‘hooked up’ to provide ozone in to water purification apparatus.

A particular advantage of the ozone-generation being provided deliberately in the water recirculating section is that ozone can be dissolved into the water at the point of ozone generation, rather than being produced as a gas by a separate ozone generator, and then bubbled into the water purification apparatus.

The ozone-generation for the present invention can be provided by any suitable process, and examples include using a gas phase production process, or an electro-chemical process through water electrolysis. Electrolysis production can be operated at a low voltage by an electrolytic cell, using water as the ‘raw material’, from which a stream of water carrying the ozone, or ‘ozone water’, can be directly manufactured. This method provides high-concentrated ozone-water relatively easily, with a simple structural configuration of one or more electrolytic cells and a power source.

US2013/0032491A1, incorporated herein by way of reference, describes one form of a membrane-electrode assembly able to produce ozone in water based on an anode and a cathode having through-holes, and a solid polymer electrolyte membrane thereinbetween in a way that can provide an ozone concentration of several parts per million, such as 3.7ppm or 4.4ppm.

WO2012/156668A1, incorporated herein by way of reference, describes another electrode assembly able to electrolyse water to produce ozone, having a number of substrate ‘lands’ in its electrochemical cell, on which layers of diamond are located.

The ozone-generation for the present invention, may be provided by any suitable ozone-generating device or unit, and may comprise one or more electrochemical or electrolytic cells, able to generate ozone into a source of water and thereby create ‘ozone water’ able to pass through the water purifying stage.

In one embodiment of the present invention, the ozone-generating unit has at least one water inlet, and at least one water outlet, which are in series with a flow of water in the water purification apparatus that is either being purified, or has been purified, or both. Optionally, the in-line ozone generating unit is located after a deioniser or a deionisation step or stage, and before the dispense section of the water purification apparatus

In one example of the present invention, the water purification apparatus has a second water purifying stage comprising a recirculation circuit comprising at least a pump, an ultra-violet radiation step, a deionisation step using a deioniser, a water quality sensor, a filter, an ozone generating unit, a point of use outlet or tap in the dispense section, and a purified water storage reservoir. Optionally, at least the pump, ultra-violet radiation step, deionisation step, water quality sensor, filter, and ozone generating unit, are in sequence.

Optionally, the present invention further comprises an ozone-generating unit controller, able to control the operation of the ozone generation. Optionally, the ozone generating unit is an automated unit that can be controlled by the controller and can operate independently of the user of the water purifying apparatus. Thus, the present invention could be automated or programmed to operate the ozone generation at a time and/or date when purified water dispense is not expected, such as 1 am on a Monday morning. Optionally, the ozone-generation is automated to operate periodically, such as once a week, or any other time or time period or setting desired by a service engineer and/or the users.

In one particular embodiment of the present invention, the method comprises at least the steps of:

(a) passing inlet water through a first water purifying stage of the water purifying apparatus comprising reverse osmosis to provide a part-purified water stream;

(b) passing the part-purified water stream through a second water purifying stage of the water purification apparatus having an ultra violet radiation section, a deioniser, and the purified water recirculation section, to provide the purified water stream to the dispense outlet,

(c) closing the dispense outlet,

(d) providing recirculation in the purified water recirculating section;

(e) providing ozone-generation in the purified water recirculating section after the deioniser;

(f) allowing the ozone to circulate around the purified water recirculating section to sanitise at least the part of the purified water recirculating section having the dispense outlet; and

(g) using the ultra violet radiation section to stop the sanitising prior to the deioniser.

In another particular embodiment of the present invention, the method comprises at least the automated steps of;
initiating a sanitisation mode;
generating a supply of ozone;
passing the supply of ozone to circulate around the purified water recirculating section to sanitise at least the part of the purified water recirculating section having the dispense outlet, and using ultra violet radiation to stop the sanitising prior to the at least one deioniser;
stopping the supply of ozone; and
returning the water purification apparatus to use. The present invention includes water purification apparatus as described herein, with an ozone-generating unit able to sanitise at least a part of the purified water recirculating section having the dispense outlet.

Optionally the water purification apparatus further comprises a first water purifying stage comprising reverse osmosis, and a second water purifying stage including the purified water recirculating section having the dispense outlet.

Optionally, the purified water recirculating section further comprises a purified water storage reservoir.

Optionally, the water purification apparatus further comprises an ozone-generating unit controller to control the ozone-generation. Referring to the drawings, FIG. 1 shows a schematic plan of a first water purification method and apparatus for producing ultrapure water from feed water.

A source of feed water, such as a tap or other main supply, provides a feed water stream 2 which can be pressurised for progression though the apparatus by an optional boost pump 4 prior to entry as a feed inlet into a pre-treatment unit 6. The pre-treatment unit 6 may comprise one or more filters or filter media, able to reduce at least the particulates in the feed water, and optionally one or both of chlorine and chloramine which can affect subsequent processes or treatments in water purification.

An outlet from the pre-treatment unit 6 provides a pre-treated water stream 8 into a reverse osmosis (RO) unit or location 10, optionally comprising one or more RO modules or cartridges, and able to remove the majority of salts, organics and any further particulates in the pre-treated water stream 8.

The pre-treatment 6 and RO 10 can comprise one water purifying stage.

The RO unit 10 provides a post-RO water stream 12, whose quality can be monitored by a first in-line water quality sensor S1, prior to providing the inlet stream 18 into an ultra violet (UV) radiation unit 20, a deioniser 24, and a filter 28.

The UV radiation unit 20 is able to wholly or substantially remove bacteria from the treated water stream 18 prior to providing an entry stream 22 for passage into a deioniser 24, such as deionisation unit or module. As described herein, the deioniser 24 provides the highest continuous refinement of the water, to provide an ultra-pure water stream 26 therefrom. The ultra-pure water 26, whose quality is monitored by a second water quality sensor S2, can be provided through a final ultra-filter 28 to a section of the water purification apparatus having a dispense outlet 39. In the example shown in FIG. 1, the dispense outlet 39 comprises a first outlet line 40, tee-piece 42, second outlet line 44 and a point of dispense 46.

The UV radiation unit 20 and deioniser 24 can comprise the water purifying stage, optionally as a second water purifying stage.

Where the ultra-pure water 26 is not immediately required at the point of dispense 46, either the water purification apparatus can cease water purification, and/or purified water 26 can be passed via the tee-piece 42 into a re-circulation section 32 which comprises a line 48 from the tee-piece 42 to a reservoir 33 to store the ultra-pure water for a time. When there is a later demand for the purified water, a pump 35 is able to re-circulate the water via a return stream 34 back into the UV unit 20 and the deioniser 24 to the point of dispense 46. When there is a period of non-demand, the pump 35 can be operated intermittently to re-circulate the water around the recirculation circuit 32 to maintain the water quality desired for the ultra-pure water 26 in a manner known in the art, and not further described herein.

In FIG. 1, there is also located an in-line ozone-generating unit 36. Various ozone-generating units are known in the art, typically using one or more electrolytic cells able to generate ozone. An example is available from Aquaecos Limited in Japan, having a camber cell capable of providing ozone in the range 0.1 to 10 ppm for a water flow in the range 0.5 to 10 L/min, and an electrode-membrane assembly with an anode, a membrane of solid polymer electrolyte, and a cathode, placed in the middle of the cell. The electrode-membrane assembly has multiple holes through which water can pass so that the water enters to the cell from one side and smoothly exits from the other side without changing the flow direction.

At a suitable time, such as when the water treatment apparatus is either quiet or a known non-use time, e.g. once a week late on a Sunday night or early on a Monday morning, an automated controller 38 switches on the ozone-generating unit 36 to generate ozone, and switches on the recirculation circuit pump 35 and the UV radiation unit 20. The in-line ozone-generating unit 36 then generates ozone directly into the ultra-pure water 26 now flowing through the ozone-generating unit 36 to create ‘ozone water’, i.e. water having ozone dissolved therein. The pump 35 will circulate the ozone water through the first outlet line 40, the tee-piece 42, into the line 48 of the recirculating section 32, into the reservoir 33, and towards the UV radiation unit 20, whose UV irradiation will destroy any remaining ozone in the water, to prevent any such ozone reaching the deioniser 24 and affecting the ionic resins therein.

The ozonation cycle can last as little as 3 minutes, and possibly up to 35 minutes, 40 minutes etc. or even an hour, depending upon the size of the reservoir, amount of water, the temperature of the water, etc.

Pre-programmed operation of the controller 38 means that the ozonation cycle requires no direct or indirect user intervention. In particular, the controller 38 can be programmed to operate at a time which is either quiet or a known non-use time.

The use of ozone also avoids any handling of strong chemicals such as chlorine tablets by a user, especially an inexperienced user who may not be used to handling strong chemicals such as chlorine tablets whose incorrect use can be catastrophic.

The use of ozone also avoids the needs for any flushing and possibly long rinsing of strong chemicals from the recirculation circuit and components in the recirculation circuit, thereby being more environmentally friendly.

In this way, there is shown in FIG. 1 an example of a first method of sanitising a section of a water purification apparatus able to provide a purified water stream having a conductivity of less than 1 μS/cm at 25° C. to a dispense outlet.

When required, the controller 38 can stop the ozone generating unit 36, and allow an amount of time for any residual ozone to be destroyed, optionally with the pump 35 running for a further period of time. Pre-calculation by a service engineer can be used to determine the amount of ozone and/or length of time required providing the desired sanitisation, which values or parameters can be programmed into the controller 38.

A service engineer can also program the controller 38 to control the frequency of ozonation and/or the automated time setting, or indeed change these parameters to whenever ozonation needs to take place, which may be of a different period and of a different frequency in different situations or locations.

Optionally, the water purification apparatus indicates to a user when ozonation is occurring, and provides a countdown timer as to when the water purification apparatus will be back online and able to provide purified water again from the point of dispense 31.

FIG. 2 shows a second water purification apparatus 50 according to another embodiment of the present invention, having the same pre-treatment 6, reverse osmosis 10, recirculation circuit 32, UV radiation unit 20, deioniser 24 and ultra-filter 28, as shown in FIG. 1.

In FIG. 2, the dispense outlet 62 comprises a first outlet line 60 from the ultra-filter 28, and a 3-way valve 64 having one outlet port providing a direct dispense port to a user, and a second outlet port leading to the line 66 to the reservoir 33.

In FIG. 2, there is also a detachable second ozone-generating unit 52. The second ozone-generating unit 52 has a water inlet 54 and a water outlet 56, which can be connected into the second water purification apparatus 50 at any suitable location, optionally where suitable outlet and inlet valves 58 are located in the first outlet line 60 after the ultra-filter 28.

Connection and operation of the second ozone-generating unit 52 can be provided by a service engineer. By use of a suitable controller (not shown), optionally in the second ozone-generating unit 52 or the second water purification apparatus 50 or co-ordinated thereinbetween, the second ozone-generating unit 52 generates ozone, and switches on the recirculation circuit pump 35. Via the water inlet and outlet 54, 56, ozone in the ultra-pure water 26 now flows through the ozone-generating unit 52 to create ‘ozone water’, i.e. water having ozone therein. The pump 35 will circulate the ozone water towards the recirculating section 32 via the 3-way valve 64 of the dispense section 62, through the reservoir 33, and towards the UV unit 20.

In a similar manner to that shown in FIG. 1, operation of the ultra-violet radiation 20 in the second water purification apparatus 50 serves to destroy any ozone prior to the deioniser 24.

In particular, this arrangement ensures that the ozone-generating unit 52 is only operated by a suitable service engineer, and that sanitisation cannot be incorrectly carried by a user, even accidentally.

FIG. 3 shows a flow diagram of an example of an automated method of sanitising a water purifying stage of a water purification apparatus able to provide a purified water stream having a conductivity of less than 1 μS/cm at 25° C., comprising using a controller to control at least the steps of;

initiating a sanitisation mode by placing or taking the apparatus off-line to stop any further water purification;

starting ozone generation by generating a supply of ozone, and starting a pump in the water purifying stage;

passing the supply of ozone to circulate around the purified water recirculating section to sanitise at least the part of the purified water recirculating section having the dispense outlet, and using ultra violet radiation to stop the sanitising prior to the at least one deioniser;

stopping the supply of ozone; and

returning the water purification apparatus to being on-line, i.e. ready for use.

The use of in-line generated ozone to sanitise a water purifying stage has a number of advantages, including in particular automation, directly dissolved ozone, being environmentally friendly compared to the use of previous sanitisation materials such as chlorine tablets, and the avoidance of requiring any rinsing and flushing steps or cycles, with its attendant waste of water going to a drain only. The use of ozone water also ensures cleaning of all surfaces by the ozone, both those contacted by the ozone water in liquid form, and, due to the formation of ozone gas in a known manner as it circulates in ozone water, any other surfaces not contacted directly by the ozone water. That is, parts of the recirculation circuit such as the upper surfaces of the reservoir tank, will also be sanitised by the use of ozone, which would not occur with the use of a sanitant material which is limited to only acting in relation to liquid contact surfaces.

1. A method of sanitising a section of a water purification apparatus able to provide a purified water stream having a conductivity of less than 1 μS/cm at 25° C. to a dispense outlet, the water purification apparatus having a purified water recirculating section including at least one deioniser and the dispense outlet, comprising at least the steps of:
(i) providing recirculation in the purified water recirculating section;
(ii) providing ozone-generation in the purified water recirculating section after the at least one deioniser;
(iii) allowing the ozone to circulate around the purified water recirculating section to sanitise at least the part of the purified water recirculating section having the dispense outlet; and
(iv) using ultra violet radiation to stop the sanitising prior to the at least one deioniser.

2. A method as claimed in claim 1 wherein step (ii) comprises providing in-line ozone-generation in the purified water recirculating section.

3-14. (canceled)

15. A water purification apparatus able to provide a purified water stream having a conductivity of less than 1 μS/cm at 25° C. to a dispense outlet, the water purification apparatus having:
a purified water recirculating section including at least one deioniser and the dispense outlet,
an ozone-generating unit able to sanitise at least a part of the purified water recirculating section having the dispense outlet; and
ultra violet radiation unit to stop the sanitising prior to the at least one deioniser.

16. A water purification apparatus as claimed in claim 15 comprising a first water purifying stage comprising reverse osmosis, and a second water purifying stage including the purified water recirculating section having the dispense outlet.

17-21. (canceled)

22. A method as claimed in claim 1, wherein the water purification apparatus further comprises one or more of the group comprising: reverse osmosis, ultrafiltration and microfiltration.

23. A method as claimed in claim 22, comprising a first water purifying stage comprising reverse osmosis, and a second water purifying stage having the purified water recirculating section.

24. A method as claimed in claim 1, wherein the at least one deioniser is one or more of the group comprising: ion exchange resins, an electro-deionisation unit, a capacitive deionisation unit, and a membrane capacitive deionisation unit.

25. A method as claimed in claim 1, wherein the purified water recirculating section further includes a purified water storage reservoir, comprising the further step of sanitising the purified water storage reservoir.

26. A method as claimed in claim 1, further comprising the step of providing an ozone-generating unit controller to automatically control the ozone-generation.

27. A method as claimed in claim 26, further comprising the step of periodically operating the ozone-generation.

28. A method as claimed in claim 1, wherein the ultra violet radiation is provided by one or more LEDs.

29. A method as claimed in claim 1, further comprising varying the ultra violet radiation used to stop the sanitising prior to the at least one deioniser.

30. A method as claimed in claim 1, wherein the ozone generated by the ozone-generation is dissolved into the water at the point of ozone generation.

31. A method as claimed in claim 30, wherein the ozone-generation is provided by an electro-chemical process through water electrolysis.

32. A method as claimed in claim 1, for sanitising a section of a water purification apparatus, comprising at least the steps of:
(a) passing inlet water through a first water purifying stage of the water purifying apparatus comprising reverse osmosis to provide a part-purified water stream;
(b) passing the part-purified water stream through a second water purifying stage of the water purification apparatus having an ultra violet radiation section, a deioniser, and the purified water recirculation section, to provide the purified water stream to the dispense outlet,
(c) closing the dispense outlet,
(d) providing recirculation in the purified water recirculating section;
(e) providing ozone-generation in the purified water recirculating section after the deioniser;
(f) allowing the ozone to circulate around the purified water recirculating section to sanitise at least the part of the purified water recirculating section having the dispense outlet; and
(g) using the ultra violet radiation section to stop the sanitising prior to the deioniser.

33. A method as claimed in claim 1, for sanitising a section of a water purification apparatus, comprising at least the automated steps of:
initiating a sanitisation mode;
generating a supply of ozone;
passing the supply of ozone to circulate around the purified water recirculating section to sanitise at least the part of the purified water recirculating section having the dispense outlet, and using ultra violet radiation to stop the sanitising prior to the at least one deioniser;
stopping the supply of ozone; and
returning the water purification apparatus to use.

34. A water purification apparatus as claimed in claim 15, wherein the at least one deioniser is one or more of the group comprising: ion exchange resins, an electro-deionisation unit, a capacitive deionisation unit, and a membrane capacitive deionisation unit.

35. A water purification apparatus as claimed in claim 15, wherein the purified water recirculating section further comprises a purified water storage reservoir.

36. A water purification apparatus as claimed in claim 15, further comprising an ozone-generating unit controller to control the ozone-generation.

37. A water purification apparatus as claimed in claim 15, wherein the ultra violet radiation is provided by one or more LEDs.

38. A water purification apparatus as claimed in claim 15, wherein the ozone-generation is provided by an electro-chemical process through water electrolysis.
